(19) United States
(12) Patent Application Publication
(10) Pub. No.: US 2015/0190013 A1
(43) Pub. Date: Jul. 9, 2015

(54) COOKING GRILL SHIELDING DEVICE

(71) Applicant: Remar S. Collera, Virginia Beach, VA (US)

(72) Inventor: Remar S. Collera, Virginia Beach, VA (US)

(21) Appl. No.: 14/499,706

(22) Filed: Sep. 29, 2014

Related U.S. Application Data
(60) Provisional application No. 61/964,539, filed on Jan. 9, 2014.

(51) Int. Cl. A47J 37/07

(52) U.S. Cl. CPC A47J 37/0786

(57) ABSTRACT

A portable barrier blocks smoke, heat, and grease spatter from coming into contact with an upper body of one who is grilling. The portable barrier includes a vertically adjustable transparent barrier arranged between two vertical risers. At least an upper portion of each vertical riser includes a C-shaped cross-section that accepts opposite ends of the transparent barrier. An adjustable opening is arranged beneath the transparent barrier and allows access to a grilling surface. A support member couples a lower portion of the vertical risers together. A base includes wheels or casters for ease in repositioning the portable barrier. The base may include a decorative panel extending between the lower region of the vertical risers which includes the base to the upper region to below the adjustable opening.

The present invention relates to U.S. Provisional Patent Application Ser. No. 61/964,539 filed on Jan. 9, 2014 and claims priority therefrom.

The present application was not subject to federal research and/or development funding.

### TECHNICAL FIELD

Generally, the invention relates to a protective device that shields a cook or other user's face and upper body from smoke, grease splatter and heat produced when grilling a food upon a grill. Specifically, the invention is a height-adjustable clear protective window arranged within a mobile frame and adjusted to a user's specific height such that the window is within the user's line of sight and between his face and the grilling surface. An access opening is arranged beneath the window and through which a user may pass his hands, food, and grilling utensils.

### BACKGROUND OF THE INVENTION

Many Americans use outdoor gas or charcoal grills to cook meals. Some hazards associated with the use of an outdoor grill are smoke, heat, and grease splatter. Those with sensitive eyes including many contact lens wearers suffer from dry eyes when operating in the heat and smoky environment of an outdoor grill. Others with sensitive facial skin or who wear makeup may experience discomfort when grilling. As most grilling surfaces are below a user's head, a fair amount of smoke and heat tend to come into contact with the user's face when grilling food. Wind tends to exasperate these operating conditions and environment causing much eye irritation, inconvenience and annoyance. The inventor of the present invention has conceived of a novel solution for overcoming these drawbacks by placing a heat and smoke reflective transparent viewing window in the line of sight between the user's face and grilling surface while providing an adjustable opening beneath which may be adjusted to a desired size.

There are a variety of protective barriers that have been previously utilized for protecting an individual. By way of example, the following devices exemplify such protective barriers. U.S. Pat. No. 2,565,905 to Belau discloses a stationary splatter guard which is a flat sheet acting as a vertical splatter guard and having a hinged member attached to its upper end. FIG. 4 shows the splatter guard arranged between a stove and a wall and fastened there via members 17 and 17′. As can be recognized by this drawing, Belau fails to disclose any mobility and does not allow for a user to pass one's hands and cooking utensils to be passed through the splatter guard as in the instant invention.

U.S. Pat. No. 3,716,975 to Smith discloses a safety shield for powered lawn equipment which protects an operator from flying debris. The safety shield is formed from metal or plastic plates which are fastened to the arms and handles of powered lawn tools.

U.S. Pat. No. 5,967,214 to Beretta discloses a barrier for delimiting spaces, indicating paths, pointing out dangers and the like. The barrier comprises a tubular frame having a closed shape and to which a sheet-like element is applied. The barrier may comprise either supporting feet or wheels.

U.S. Pat. No. 6,866,035 to Haemerle discloses a freestanding portable splatter shield that includes a central panel and first and second end panels pivotally attached to the respective opposite end portions of the central panel. The first and second end panels are selectively positioned at a plurality of different angular orientations to relative to the central panel to accommodate different work areas. The portable splatter shield is foldable or collapsible into a compact storage position such that the end panels are substantially parallel to the central panel in an overlaying relationship.

U.S. Pat. No. 7,168,881 to Hartlauer discloses a movable barrier for perimeter protection. A high-mass barrier element is adapted to be rolled into a blocking position to obstruct the flow of traffic and rolled into an open position to permit unobstructed flow of traffic though an access control point.

U.S. Pat. No. 8,162,272 to Trott discloses a window maintenance apparatus for a tilt-in sash which includes a base leg for extending upwards from a floor towards a window. The base leg includes a first foot resting on the floor. A hinged leg is joined to the base leg proximate an end of the base leg for extending generally downwards towards the floor.

U.S. Pat. No. 8,544,459 to Rees, Jr. discloses a portable grill assembly having a frame and a plurality of legs that are pivotally attached to the frame. A removable tray is matingly received within the frame and a screen is removably nested within the tray in spaced relation to the bottom of the removable tray to provide room for charcoal to be burned. At least one wind screen is detachably secured in the frame adjacent the grill to block wind from blowing on the grill.

### SUMMARY OF THE INVENTION

The instant invention is an adjustable-height upright portable barrier that may be positioned between a grill and an upper body of a user. The barrier comprises a clear shield through which a user may view a grilling surface and any food arranged thereon. The clear shield may comprise a polycarbonate sheet of plastic or other such plastic sheeting that is durable, heat resistant, and impact resistant such as that sold under the brand name of Lexan®. In the preferred embodiment, the clear shield includes a frame for protecting the user's hands from sharp edges. Tempered glass may also be utilized in implementing the invention.

A pair of vertical risers extend upwards from a base. Each vertical riser includes an upper region that comprises a track formed generally in a C-shape when viewed from above. A first and second plurality of adjustment holes are formed in the tracks. These openings are provided at the same elevation as another pair of adjustment holes in the opposite track. Opposite edges of the frame of the clear shield are arranged within the tracks. In a first embodiment, a single adjustment rod extends through the opening in one of the vertical risers to an opening in the other of the vertical risers. In a second embodiment, a first adjustment rod is inserted into a pair of openings on the track of the first vertical riser. A second adjustment rod is inserted into a pair of openings on the other track arranged at the same elevation as the openings on the first vertical riser. The bottom of the frame rests atop the first and second adjustment rods. The rods may be removed and inserted into openings at different elevations to accommodate a variety of different grills having various heights. Thus, in the second embodiment the retractable rods are arranged on opposite sides of the bottom of the shield.

A brace couples the lower portion of the pair of vertical risers together to assure stability of the portable barrier. An opening is defined between the bottom of the window frame and the brace for allowing access to the grill to manipulate and cook food. A base is arranged beneath the brace and may comprise a connecting member that couples the bottom end of each vertical riser together. A pair of base members is arranged at opposite ends of the connecting member beneath each vertical riser. Each base member is arranged perpendicular to the connecting member. Casters or wheels may be included on a bottom of each base member. In the preferred embodiment, each base member weighs ten pounds for maintaining the device in place during windy conditions. One end of the connecting member may be permanently fastened to one of the base member. An opposite end of the connecting member may be inserted into a recess in the opposite base member and locked into place to couple the pair of base members together. Additional features such as hinged vertical risers may be incorporated into the invention for use in storing and easily transporting the device.

It is an object of the invention to provide a grill shield that protects wearers of contact lens, makeup and those having sensitive skin during a food grilling operation.

It is further object of the invention to provide a grilling shield that may be adjusted from an elevation that is equal to or slightly above the elevation of a grilling surface and having a maximum height of preferably seventy-eight inches (78″).

It is an object of the invention to provide an adjustable window that varies in height according to a user's height and a height of a grilling surface. In this manner, the adjustable window may be elevated to an optimal height for shielding the user's face and eyes from the environmental hazards of grilling food like heat and smoke.

It is an object of the invention to provide a clear window comprising a Lexan® type plastic or tempered glass that is both heat and smoke resistant and easy to clean. The device may be used as a shield when working using a table saw or other device to shield the user from flying debris.

Additional objects and advantages of the invention will be set forth in part in the description which follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1A shows a perspective view of a first embodiment of the invention. FIG. 1B is a front view of the first embodiment. FIG. 1C is a side view of the first embodiment.

FIG. 2A shows a perspective view of second embodiment of the invention. FIG. 2B is a front view of the second embodiment. FIG. 2C is a side view of the second embodiment.

FIG. 3A shows a third embodiment having an adjustable width for accommodating grills having various widths. FIG. 3B shows a close-up of one end of a base for the third embodiment. FIG. 3C shows an opposite end of the base for the third embodiment.

FIG. 4A shows a hinged embodiment of the invention with the vertical riser and base in a working position. FIG. 4B shows the hinged embodiment of the invention with the vertical riser being raised into a storage position with is all the way up and ninety degress from the working position.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

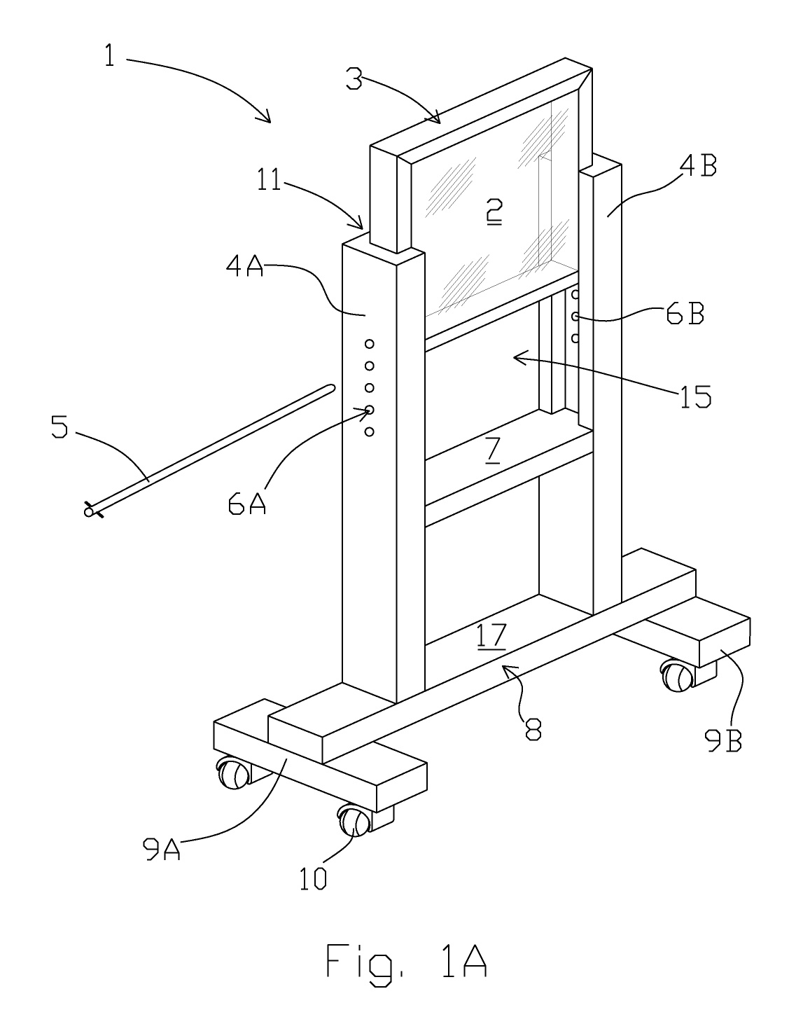

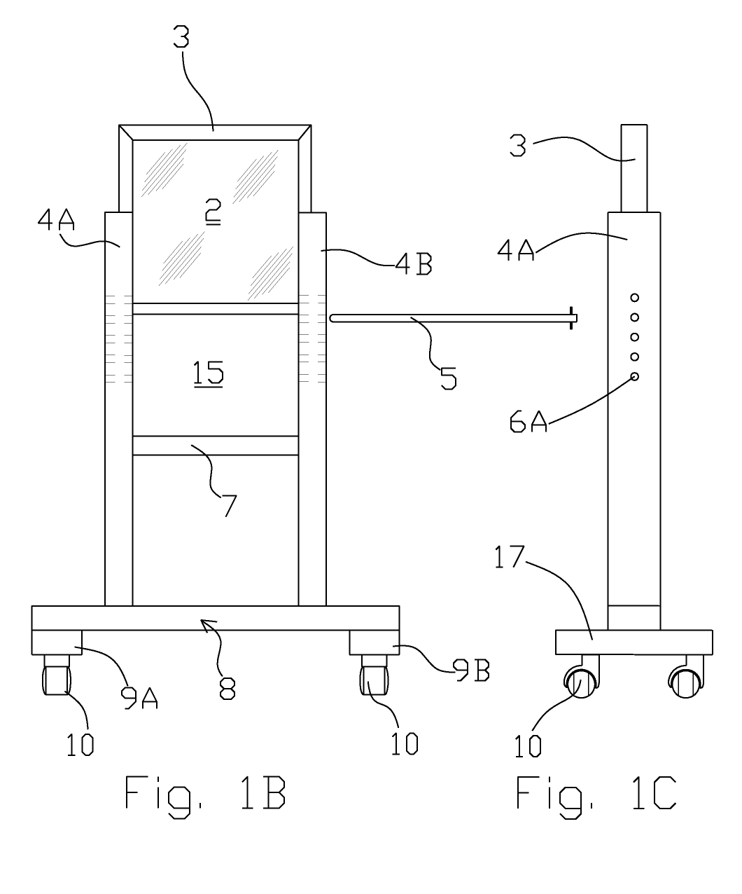

FIGS. 1A-1C show an embodiment of the grill protector 1 that includes a clear window 2 for providing an unobstructed view of the grilling surface. The clear window 2 comprises Lexan® or tempered glass surrounded by frame 3. Frame 3 includes a pair of sides that slide vertically within tracks 11 located on vertical risers 4A, 4B and protects the user from sharp edges. A grilling surface access opening 15 is arranged below window 2 and is adjusted by raising or lowering window 2. The vertical risers 4A, 4B a generally C-shaped when viewed from above as can be recognized in the figures. The C-shape of each vertical riser creates a track into which opposite edges of the window 2 slides. A plurality of openings 6A, 6B is arranged along an edge of each respective vertical riser 4A, 4B at corresponding heights. A height adjustment pin 5 extends through one of the openings 6A and into a corresponding opening in plurality 6B, such that a bottom of the frame 3 rests atop the adjustment pin 5. This allows the user to adjust clear window 2 to a specific height to within a user's line of sight that extends from the user's eyes to the grilling surface. A brace 7 couples the lower portion of the pair of vertical risers 4A, 4B together to assure stability of the portable barrier. The adjustable opening 15 is defined between the bottom of the window frame and the brace 7 for allowing access to the grill to manipulate and cook food. A base 8 is arranged beneath the brace and may comprise a connecting member 17 that couples the bottom end of each vertical riser together. A pair of base members 9A, 9B is arranged at opposite ends of the connecting member 17 beneath each vertical riser. Each base member is arranged perpendicular to the connecting member. Casters or wheels 10 may be included on a bottom of each base member. In the preferred embodiment, each base member weighs ten pounds for maintaining the device in place during windy conditions.

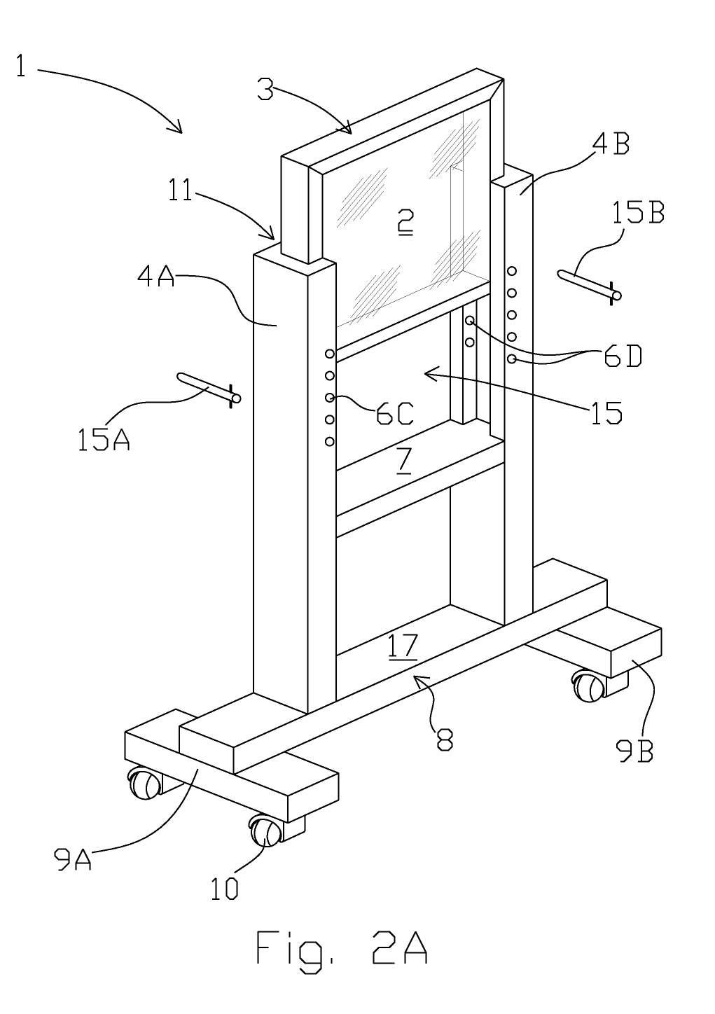

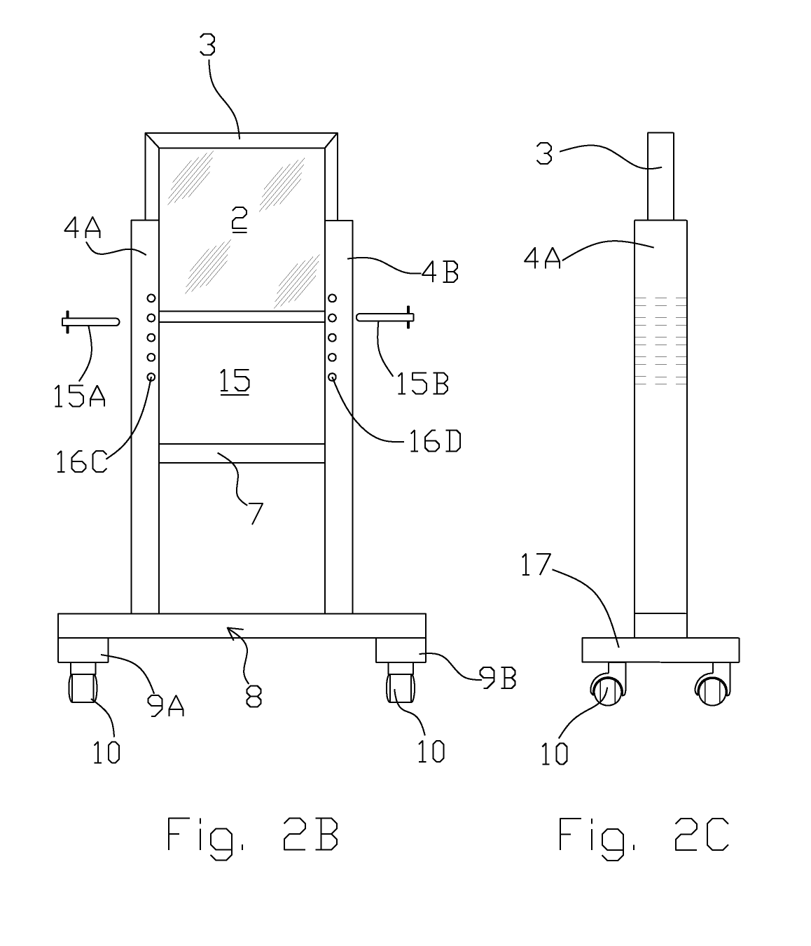

FIGS. 2A-2C show a second embodiment of the invention wherein the height adjustment pin 5 is substituted for a pair of shorter height adjustment pins 15A, 15B which extend into openings 6C, 6D. Openings 6C, 6D are perpendicular to those shown in FIGS. 1A-1C. In this embodiment, the first and second plurality of openings comprises four openings that are arranged at substantially the same elevation. The broken lines in FIG. 1B and FIG. 2C represent the openings 6A-6D and the portions of the vertical risers in which the openings are formed. As can be recognized, the user selects a desired height and inserts pins 15A and 15B into respective openings on the vertical risers.

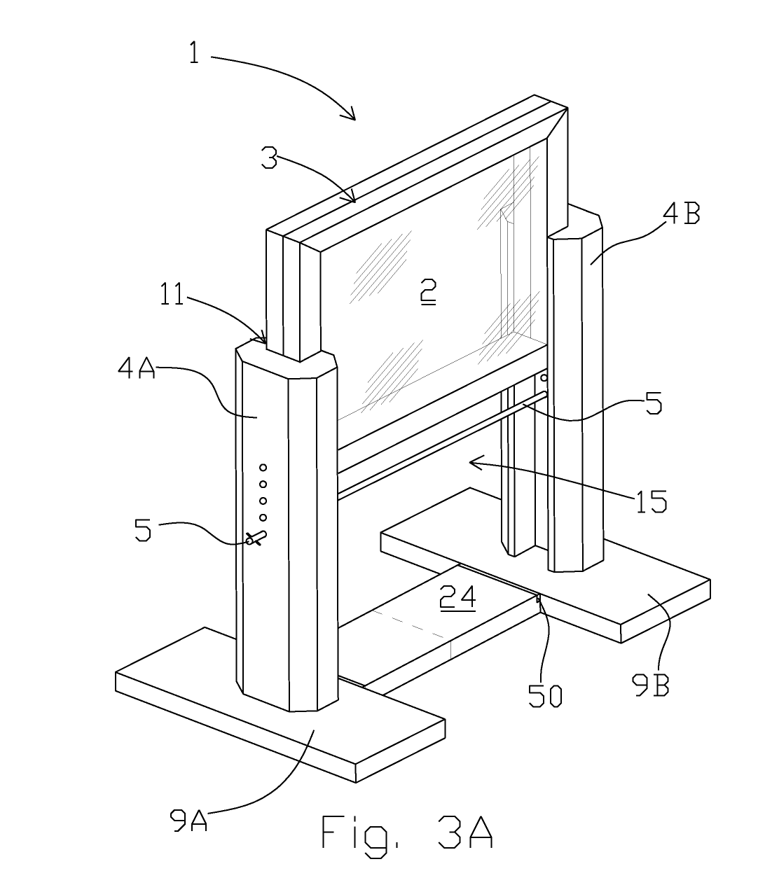

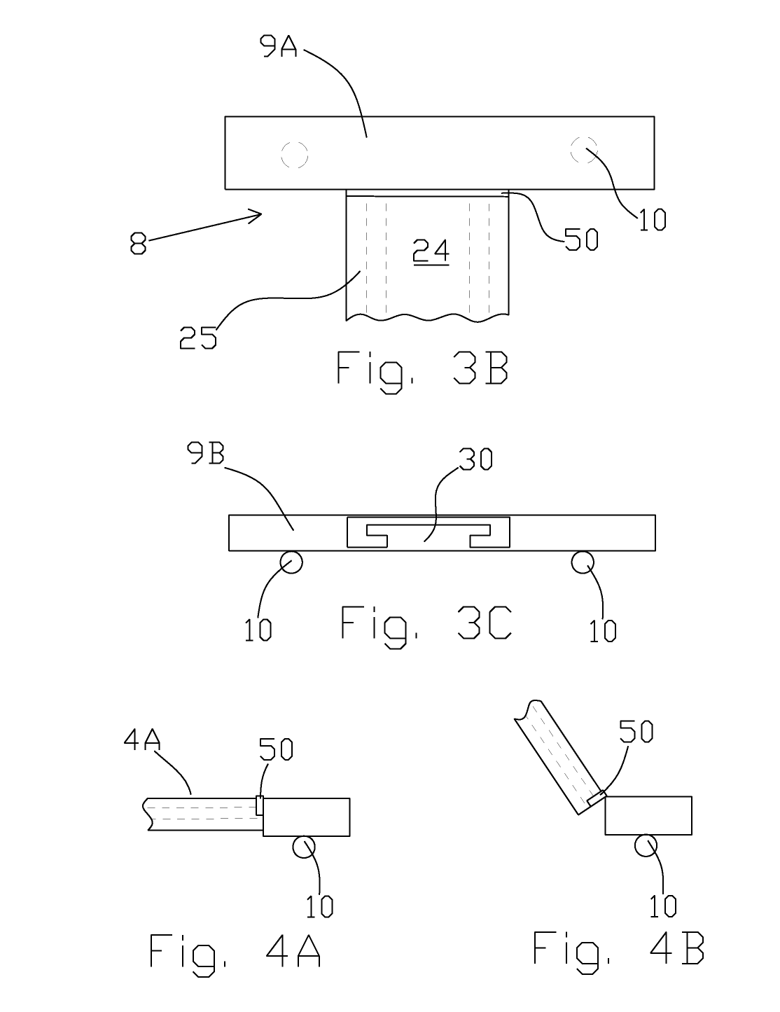

FIG. 3A shows an embodiment of the invention wherein the base 8 comprises base members 9A, 9B and may be separated as indicated by the broken line. As more clearly shown in FIGS. 3B, 3C, one end includes a male end 25 having a complementary T-shape which snuggly fits within recess 30. In this manner, the device may be separated for ease in moving and storing the device. One end of the connecting member 24 is permanently fastened to one of the base member as shown in FIG. 3B. An opposite end of the connecting member 24 may be inserted into a recess in the opposite base member and locked into place to couple the pair of base members together. FIGS. 4A, 4B show a hinge 50 arranged between the base 9A and the vertical riser 4A. As can be understood, the base 9A may be rotated upwards for storage purposes. In the third embodiment, the bases 9A and 9B may have the vertical risers attached via a hinge to allow to raise ninety degress from horizontal for transport and storage.

It is to be understood that the invention is not limited to the exact construction illustrated and described above, but that various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A protective shield grilling device comprising a height-adjustable clear window arranged within an upper portion of a frame comprising a pair of vertical risers having a track formed there between, an adjustable opening arranged directly below said height-adjustable clear window, at least one height adjustment pin securing the height-adjustable clear window to a specific height through at least one opening in each of the vertical risers and directly below the height-adjustable clear window that is arranged within a user's line of sight extending from the user's eyes to the grilling surface, and said pair of vertical risers connected to a mobile base.

2. The protective shield grilling device of claim 1 further comprising the clear window formed from one of Lexan® or tempered glass.

3. The protective shield grilling device of claim 1 wherein said at least one height adjustment pin comprises a pair of adjustment pins, each pin extending into a pair of openings in one of the pair of vertical risers such that said height-adjustable clear window rests atop the pair of pins.

4. The protective grilling device of claim 1 further comprising a pair of hinges, each hinge fastened between one of the vertical risers and the base.

5. The protective grilling device of claim 1 wherein said base includes a pair of base members, one base member having a connecting member that inserts into a recess of the other base member.

6. The protective grilling device of claim 5 wherein each of said base members weighs ten pounds.

7. A grill shield comprising:
a base having a pair of wheels;
a pair of vertical risers extending from said base upwards and terminating in a portion having a C-shape cross-section comprising a first face coupled to a second face via an exterior surface, said first face and second face each comprising a plurality of height-adjustable openings arranged at substantially the same height from each elongated base member;
a first pin extending through a pair of the plurality of height-adjustable through openings in the first face and the second face of one of the pair of vertical risers to create a first support surface;
a second pin extending through a pair of the plurality of height-adjustable through openings in the first face and the second face of the other of the pair of vertical risers to create a second support surface;
a window arranged atop the first and second support surfaces at substantially the same elevation and having opposite sides within the C-shape cross section of each of the pair of the vertical risers; and,
an adjustable opening being arranged beneath the window and being adjusted by removing the first and second pins and sliding the window upwards or downwards to a desired height and replacing the pins into a different pair of through openings.

8. The grill shield of claim 7 further comprising the window formed from one of Lexan® and tempered glass.

9. The grill shield of claim 7 further comprising a pair of hinges, each hinge fastened between one of the vertical risers and the base.

10. The grill shield of claim 7 wherein said base includes a pair of base members, one base member having a connecting member that inserts into a recess of the other base member.

11. The protective grilling device of claim 10 wherein each of said base members weighs ten pounds.

12. A method of grilling food comprising:
providing a protective shield grilling device comprising a height-adjustable clear window arranged within an upper portion of a frame comprising a pair of vertical risers having a track formed there between, an adjustable opening arranged directly below said height-adjustable clear window, at least one height adjustment pin securing the height-adjustable clear window to a specific height through at least one opening in each of the vertical risers and directly below the height-adjustable clear window and said pair of vertical risers connected to a mobile base which deflect heat and smoke;
arranging said height-adjustable clear window in the line of sight of the user between the user's eyes and a grilling surface to deflect heat and smoke; and,
arranging the adjustable opening to a height that allows the user to extend one's hands through the adjustable opening to manipulate food on the grilling surface.
